(19) United States
(12) Patent Application Publication
(10) Pub. No.: US 2009/0020184 A1
(43) Pub. Date: Jan. 22, 2009

(54) Portable planing machine

(76) Inventors: Carl F. Merhar, Jackson, TN (US); Stephen L. Vick, Reisterstown, MD (US); Steve Carnal, Milan, TN (US); Vincent Chen, Taichung City (TW)

Correspondence Address: Mehul R. Jani;Black & Decker Corporation, Mail Stop TW199, 701 E. Joppa Rd, Towson, MD, 21286, US

(21) Appl. No.: 11/879,056

(22) Filed: Jul. 16, 2007

(51) Int. Cl. B27C 1/00

(52) U.S. Cl. 144/129; 15/300.1

(57) ABSTRACT

An improved planing machine for performing an operation on the surface of wooden planks or boards is provided. The planing machine includes a base, at least two support columns disposed on the base, and a carriage assembly carrying a cutterhead. The carriage assembly may be mounted on the support columns. At least one of the base and the carriage assembly is movable vertically towards the other of the base and the carriage assembly. In an exemplary embodiment, the planing machine includes a depth stop adjustment mechanism which allows the operator to accurately select a minimum workpiece depth from one or more predetermined depths. In another exemplary embodiment. The planing machine includes a dust exhaust channel for removing dust and wood chips/shaving generated during the planing operation.

### FIELD OF THE INVENTION

The present invention generally relates to woodworking. More particularly, the present invention relates to a portable wood planing machine for the surface planing of wooden planks or boards.

### BACKGROUND OF THE INVENTION

Various power tools are used in woodworking in an effort to efficiently and accurately cut workpieces to desired dimensions and surface quality. As is widely known, planing machines are often used for surface planing of wooden boards. A conventional planing machine typically includes one or more rotatably mounted cutting blades attached to a vertically movable carriage assembly. Also known are jointer machines which are typically used for the edge planing of wood. In certain applications, the functions of conventional planing machines and jointers are combined within a single unit commonly referred to as a jointer/planer machine.

In a typical wood planing machine, such as a surface planer, a selectively adjustable workpiece opening is defined between a carriage assembly and a support surface. The one or more rotationally mounted blades are carried on the underside of the carriage assembly adjacent the workpiece opening. The blades are adapted to remove a predetermined amount of material from the workpiece depending on the height of the workpiece opening. The carriage assembly also usually includes one or more feed rollers which urge the workpiece through the workpiece opening during operation of the wood planing machine.

In most applications, the carriage assembly of a wood planing machine is movably mounted to a plurality of support columns for movement with respect to a workpiece support surface, such as a base or platen. Such movement of the carriage assembly adjusts the vertical dimension of the workpiece opening so as to selectively determines the amount of material to be removed from the workpiece. Alternatively, in certain applications it is desirable to fixedly mount the carriage assembly and to adjust the workpiece opening by moving the base or platen vertically with respect to the carriage assembly.

In use, a workpiece is passed through the workpiece opening and a predetermined amount of material is removed from the surface of the workpiece adjacent the carriage assembly. Multiple passes of the workpiece through the workpiece opening are often necessary to obtain the desired thickness and surface quality. As with other woodworking operations, it is desirable that a planing machine accomplish workpiece preparation with precise tolerances, high surface quality, and a significant degree of reproducible results.

In the field of woodworking it is desirable to provide a wood planing machine having a depth stop mechanism which serves to physically stop the lowering of the carriage assembly at a predetermined depth. Additionally, it is desirable to provide a wood planing machine having a depth stop adjustment which may be more adjustable and more quickly set to a desired depth as compared to prior known devices.

It is also known in the field of woodworking to provide dust collection for a wood planing machine which provides for removal of dust and debris generated from the material removal from a workpiece. While prior known devices are available for dust collection, all are associated with one or more disadvantages. To overcome the disadvantages of prior known devices, it is desirable to provide a dust collector assembly for a wood planing machine which can have a smaller outlet for evacuating the dust but still will not clog or lose capacity.

### SUMMARY OF THE INVENTION

In accordance with the present invention, an improved planing machine is employed. The planing machine may include a base, at least two support columns disposed on the base, a carriage assembly carrying a cutterhead, the carriage assembly being mounted on the support columns, one of the workpiece support surface and the carriage assembly being movable vertically towards the other of the workpiece support surface and the carriage assembly. In an exemplary embodiment, the planing machine includes a depth stop adjustment mechanism which allows the operator to accurately select a minimum workpiece depth from one or more predetermined depths. In another exemplary embodiment, the planing machine includes a dust exhaust channel for removing dust and wood chips/shaving generated during the planing operation

Additional features and benefits of the present invention are described, and will be apparent from, the accompanying drawings and the detailed description below.

### BRIEF DESCRIPTION OF THE DRAWINGS

Additional objects and advantages of the present invention will become apparent from a reading of the following detailed description of the preferred embodiments which make reference to the drawings of which:

FIG. 1 is a perspective view of a portable wood planing machine constructed in accordance with a preferred embodiment of the present invention;

FIG. 2 is an enlarged partial perspective view of a first portion of the depth stop adjustment mechanism of FIG. 1;

FIG. 3 is an enlarged perspective view of a second portion of the depth stop adjustment mechanism of FIG. 1, in particular, a rear portion of the depth stop mechanism handle;

FIG. 4 is a schematic diagram illustrating the depth stop adjustment mechanism for the planing machine;

FIG. 5 is a schematic diagram illustrating a dust exhaust for the planing machine;

FIG. 6 is a rear perspective view of the dust exhaust of FIG. 5.

### DETAILED DESCRIPTION

As required, detailed embodiments of the present invention are disclosed herein. However, it is to be understood that the disclosed embodiments are merely exemplary of the invention which may be embodied in various forms. Therefore, specific functional and structural details disclosed herein are not to be interpreted as limiting, but merely as a basis for the claims and as a representative basis for teaching one skilled in the art to variously employ the present invention in virtually any appropriately detailed structure.

The present invention provides an improved portable wood planing machine for the surface planing of a workpiece such as a wooden board or plank. As will become apparent below, the present invention more particularly relates to various features of a planing machine. Many of these various features, which are described in detail below, are shown cooperatively arranged within a single planing machine. However, it will be appreciated that the scope of the present invention as it independently relates to each of the features described is not so limited. In other words, while an exemplary embodiment of a planing machine is shown and described, it will be understood that the various features may be utilized independent from one another.

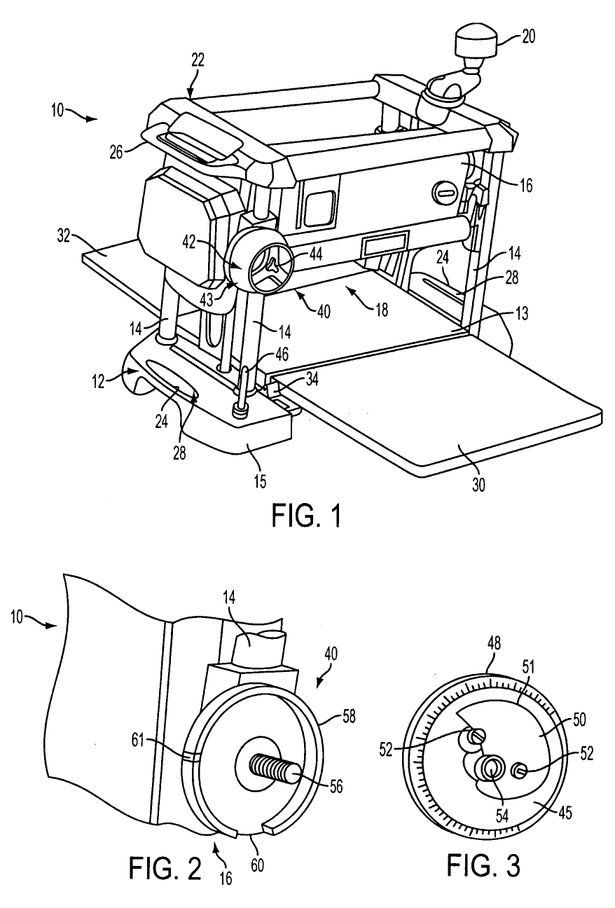

With reference to FIG. 1, a planing machine constructed in accordance with the teachings of the present invention is generally indicated by reference numeral 10. The planing machine 10 may include a base assembly 12 including a support platen 13 and feet 15, at least two, but preferably four, support columns 14, and a carriage assembly 16 mounted on the support columns 14. Carriage assembly 16 may carry a motor, a cutterhead 17 (shown in FIG. 5) driven by the motor, and/or feed rollers driven by the motor, as is well known in the art.

In the embodiment shown, the carriage assembly 16 is preferably slideably mounted on four support columns 14 for bidirectional vertical movement. The carriage assembly 16 may be selectively translated upwardly or downwardly along a path of travel along the support columns 14 by a user via operation of handle 20. An exemplary arrangement for translating the carriage assembly is described in further detail in U.S. Pat. No. 5,771,949 entitled, “Portable Wood Planing Machine” and U.S. Pat. No. 5,725,035 entitled, “Apparatus for Adjusting the Relative Positions of Two Components of a Power Tool”, both of which are incorporated herein by reference. The carriage assembly 16 preferably cooperates with the support platen 13 to define a workspace opening 18 into which a workpiece may be inserted.

Base assembly 12 as well as top assembly 22 may include handles 24 and 26, respectively, for enabling the user to carry the planing machine 10. Preferably, base assembly 12 includes openings 28 which allow a user to wrap his or her hand around the handle 24 and comfortably insert his or her fingers into the openings 28. With respect to handles 26, they preferably extend outwardly from top assembly 22 allowing a user to comfortably wrap his or her hand around the handle 26 without any interference from the top assembly 22.

With continued reference to FIG. 1, planing machine 10 also preferably includes forwardly and rearwardly extending feed tables 30 and 32 for further supporting the workpiece during operation of the planing machine 10. In a preferred embodiment, the forwardly and rearwardly extending feed tables 30 and 32 are each pivotally attached to the base assembly 12 through a pair of pivot supports 34 which are fixedly attached to the base assembly 12. The means to attach feed tables 30 and 32 to pivot support 34 are conventional and can include any number of fasteners and/or rods. Since feed tables 30 and 32 are pivotally attached to the base assembly 12, they can then be folded upwardly from their positions shown in FIG. 1 to storage positions substantially adjacent the front and rear of the planing machine 10, respectively, when the planing machine 10 is not in use.

Turning now to FIGS. 1-3, planing machine 10 also preferably includes infinite depth stop mechanism 40, constructed in accordance with the teachings of the present invention, for limiting the downward movement of carriage 16 toward platen 13. Infinite depth stop mechanism 40 preferably includes an adjustment knob 42 which is rotatably connected to the planing machine 10 and movable with carriage assembly 16, a locking member 44 which is operably connected to adjustment knob 42, and a stop rod 46 which is fixedly connected to base assembly 12. In another exemplary embodiment, stop rod 46 may be adjustably connected to base assembly 12. In yet another preferred embodiment, adjustment knob 42 may be rotatably attached to base assembly 12 and stop rod 46 may be fixedly or adjustable attached to carriage assembly 16. The operation of infinite depth stop mechanism 40 is explained below.

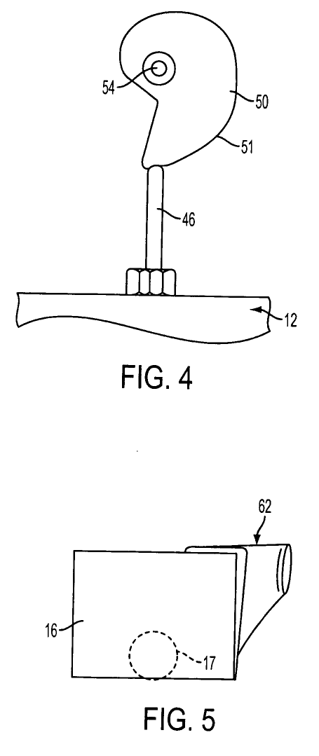

Looking at FIGS. 1 and 3, adjustment knob 42 has a front or outward side 43 which is configured and dimensioned for user interfacing and a rear or inward side 45, which can best be seen in FIG. 3. The front or outward side 43 may include texturing to facilitate gripping by the user and preferably includes a scale 48 to provide a user with visual indication of a desired measurement or setting. In a preferred embodiment, adjustment knob 42 also includes cam 50 on rear or inward side 45 thereof. Cam 50 is preferably mounted to adjustment knob 42 in a manner that allows cam 50 to move with adjustment knob 42. In an exemplary embodiment, cam 50 is mounted on inward side 45 of adjustment knob 42 via a plurality of fasteners 52. Although cam 50 is shown attached via a plurality of fasteners 52, other means of fastening are also contemplated including chemical bonding, molding, and welding. As can be seen best in FIGS. 3 and 4, cam 50 preferably has a generally nautilus shape and includes a central aperture 54, which, in a preferred embodiment is at least partially threaded and extends through adjustment knob 42.

With reference to FIG. 2, a portion of planing machine 10 can be seen where adjustment knob 42 preferably is mounted to carriage assembly 16. In a preferred embodiment, a portion of carriage assembly 16 that is mounted on support column 14 also includes post 56, which is at least partially threaded in a preferred embodiment, and frame 58. Frame 58 also preferably includes opening 60 and an indicator 61, which is used in conjunction with scale 48. Although adjustment knob 42 is shown to include scale 48 and frame 58 is shown to include indicator 61, in another preferred embodiment, frame 58 may include a scale and adjustment knob 42 may include an indicator. In a preferred embodiment, adjustment knob 42 is mounted to planing machine 10 by threadably attaching adjustment knob 42 to post 56 via central aperture 54. Adjustment knob 42 is preferably mounted in such a manner as to abut frame 58 when mounted to planing machine 10.

In another preferred embodiment, adjustment knob 42 may be mounted to base assembly 12 instead of carriage assembly 16 and stop rod 46 may be mounted to carriage assembly 16 instead of base assembly 12. In this preferred embodiment, a portion of base assembly 12 that is near support column 14 also includes post 56, which is at least partially threaded in a preferred embodiment, and frame 58. Frame 58 also preferably includes opening 60 and an indicator 61, which is used in conjunction with scale 48. Although adjustment knob 42 is shown to include scale 48 and frame 58 is shown to include indicator 61, in another preferred embodiment, frame 58 may include a scale and adjustment knob 42 may include an indicator. In a preferred embodiment, adjustment knob 42 is mounted to planing machine 10 by threadably attaching adjustment knob 42 to post 56 via central aperture 54. Adjustment knob 42 is preferably mounted in such a manner as to abut frame 58 when mounted to planing machine 10.

Turning back to FIG. 1, located preferably in the center of adjustment knob 42 is a locking member 44 configured to lock adjustment knob 42 in place once a user has set adjustment knob 42 in the desired position. In a preferred embodiment, locking member 44 will include an opening, preferably a threaded opening, that will threadably attach to post 56. The operation of the locking member 42 will be described below.

In an exemplary use of infinite depth stop mechanism 40, a user would first rotate adjustment knob 42 to the desired measurement or setting with the assistance of scale 48 and indicator 61. As adjustment knob 42 is rotated, cam 50 is also rotated since cam 50 is fixedly attached to adjustment knob 42. The user then locks adjustment knob 42 in place by turning locking member 44 and moving locking member 44 into further threaded engagement with post 56. In a preferred embodiment, as locking member 44 is further threaded onto post 56, locking member 44 locks adjustment knob 42 in place by a threaded friction or interference fit. Once adjustment knob 42 is locked in place, the user lowers carriage assembly 16 towards platen 13 by actuating handle 20. As carriage assembly 16 approaches the desired depth, depth stop mechanism 40 will prevent carriage assembly 16 from lowering beyond the desired depth measurement.

With reference to FIG. 4, as carriage assembly 16 approaches the desired depth, stop rod 46 will abut cam 50 on abutment surface 51 by entering frame 58 via opening 60. The abutment of stop rod 46 with abutment surface 51 of cam 50 will prevent further downward movement of carriage assembly 16 toward platen 13. In a preferred embodiment, the generally nautilus shape of cam 50 allows a user to choose the desired depth stop measurement at any desired increment because abutment surface 51 of cam 50 is an arcuate surface with a variable curvature. Furthermore, the variable curvature of the arcuate surface of abutment surface 51 of cam 50 prevents back driving of cam 50 once cam 50 is engaged by stop rod 46.

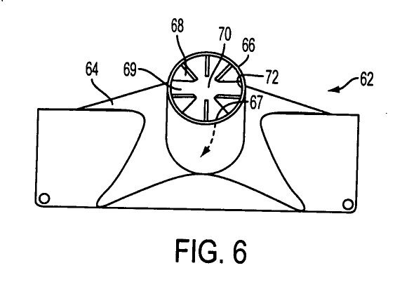

Turning now to FIGS. 5-6, planing machine 10 also preferably includes dust exhaust 62, constructed in accordance with the teachings of the present invention, for exhausting dust or wood chips/shaving generated by the cutterhead during the planing operation. Persons of skill in the art are directed to U.S. Pat. No. 6,601,621, which is incorporated herein by reference, for exemplary information of how dust generated during a planing operation exits through a dust exhaust.

Dust exhaust 62 is preferably removably attached to carriage assembly 16 via a plurality of fasteners. However, it is further contemplated that dust exhaust 62 may be attached to carriage assembly 16 in a number of ways including chemical bonding, welding, and molding. In a preferred embodiment, dust exhaust 62 includes shroud 64 and exhaust channel 66. Shroud 64 is preferably configured and dimensioned to attach to carriage assembly 16 in a manner to allow for airflow from the cutterhead to exhaust channel 66. As is well known in the art, a vacuum source is preferably attached to exhaust channel 66 to exhaust the dust and wood chips/shaving generated during the planing operation. The vacuum source may be attached to exhaust channel 66 in a variety of way including an interference fit, a threaded fit, or via fasteners.

Turning to FIG. 6, a preferred embodiment of exhaust channel 66 can be seen. Exhaust channel 66 includes at least one, but preferably includes a plurality of ribs 68.

With power tools, such as planing machine 10, that generate a high volume of dust and wood chips/shavings, there is a potential for those shaving/chips to block or clog the dust exhaust channel, particularly when the dust exhaust channel diameter is smaller. The plurality of ribs 68 prevents or at least substantially prevents the clogging of exhaust channel 66 with dust and wood chips/shavings. Furthermore, ribs 68 substantially prevent the introduction of foreign objects from the environment into the carriage assembly 16 via exhaust channel 66.

In a preferred embodiment, ribs 68 are not connected across exhaust channel 66, rather ribs 68 leave center portion 70 of exhaust channel 66 substantially unobstructed. Furthermore, in a preferred embodiment, ribs 68 have a substantially tapered configuration where the portion of ribs 68 adjacent to wall 72 of exhaust channel 66 are longer in length and the portion of the ribs 68 near center 70 of exhaust channel 66 are shorter in length. In addition, the tapered configuration is such that the direction of taper follows in the direction opposite of the airflow from the cutterhead to the vacuum source. In other words, ribs 68 extend toward center portion of 70 increasingly in the direction from inner end 67 of exhaust channel 66, which is closest to the cutterhead, to outer end 69 of exhaust channel 66. This preferred rib pattern shed dust and shaving/chips, funneling them towards center 70 of exhaust channel 66, substantially preventing the dust and shaving/chips from building up in exhaust channel 66 eventually leading to a block or clog of exhaust channel 66.

While the above description constitutes the preferred embodiment and various alternative constructions of the present invention, it will be appreciated that the invention is susceptible to modification, variation, and change without departing from the proper scope or fair meaning of the present invention. In this regard, while the various features of the present invention have been shown and described in connection with a portable wood planer, it will be appreciated by those skilled in that art that many of these features are suitable in connection with other woodworking power tools. For example, many of the features may be readily modified for use with a jointer machine or a combination jointer/planer machine. Further, it will be understood that the teachings of the present invention are equally applicable for planing machines in which a portion of the base is moved relative to a stationary carriage assembly or cutting head.

What is claimed is:

1. An apparatus for performing a forming function on a workpiece, the apparatus comprising:
a base;
a plurality of support columns disposed on the base;
a carriage assembly interconnected to the support columns, the carriage assembly including a workpiece forming element;
a workpiece support surface disposed on the base and disposed relative to the carriage assembly so as to define a selectively adjustable workpiece opening therebetween;
one of the carriage assembly and the workpiece support surface being vertically moveable towards the other of the workpiece support surface and the carriage assembly; and
a depth stop mechanism disposed on one of the carriage assembly and the base,
wherein the depth stop mechanism includes a cam having a generally arcuate abutment surface.

2. The apparatus if claim 1, wherein the depth stop mechanism also includes an adjustment knob.

3. The apparatus of claim 2, wherein the adjustment knob includes a peripheral surface that is textured to facilitate gripping the adjustment knob.

4. The apparatus of claim 2, wherein the adjustment knob includes one of a scale and an indicator.

5. The apparatus of claim 2, wherein the cam and the adjustment knob include a central opening and wherein at least a portion of the central opening is threaded.

6. The apparatus of claim 1, wherein one of the carriage assembly and base includes a post and a frame surrounding the post and wherein at least a portion of the post is threaded and at least a portion of the frame includes an opening.

7. The apparatus of claim 7, wherein the frame includes one of a scale and an indicator.

8. The apparatus of claim 2, wherein the depth stop mechanism includes a locking member for locking the adjustment knob in place.

9. The apparatus if claim 1, wherein one of the base and carriage assembly includes a stop rod configured and dimensioned to abut the cam.

10. An apparatus for performing a forming function on a workpiece, the apparatus comprising:
a base;
a plurality of support columns disposed on the base;
a carriage assembly interconnected to the support columns, the carriage assembly including a workpiece forming element;
a workpiece support surface disposed on the base and disposed relative to the carriage assembly so as to define a selectively adjustable workpiece opening therebetween;
one of the carriage assembly and the workpiece support surface being vertically moveable towards the other of the workpiece support surface and the carriage assembly; and
a dust exhaust connected to the carriage assembly, the dust exhaust including a shroud and an exhaust channel, the exhaust channel having a wall,
wherein the exhaust channel includes a plurality of substantially tapered ribs and wherein the direction of taper extends from an outer end of the exhaust channel to an inner end of the exhaust channel.

11. The apparatus of claim 10, wherein the ribs have a base portion and a tip portion and the ribs substantially taper from the base portion to the tip portion.

12. The apparatus of claim 10, wherein a portion of ribs substantially adjacent to the wall of the exhaust channel are longer in length and the portion of the ribs near center of the exhaust channel are shorter in length.

13. The apparatus of claim 10, wherein the exhaust channel is connected to a vacuum source.

14. The apparatus of claim 1, wherein the cam has a generally nautilus shape.

15. A dust exhaust apparatus, comprising:
a shroud; and
an exhaust channel, the exhaust channel having a wall,
wherein the wall of the exhaust channel includes a plurality of substantially tapered ribs and wherein the direction of taper extends from an outer end of the exhaust channel to an inner end of the exhaust channel.

16. The apparatus of claim 15, wherein the ribs have a base portion and a tip portion and the ribs substantially taper from the base portion to the tip portion.

17. The apparatus of claim 15, wherein a portion of ribs substantially adjacent to the wall of the exhaust channel are longer in length and the portion of the ribs near center of the exhaust channel are shorter in length.

18. The apparatus of claim 15, wherein the exhaust channel is connected to a vacuum source.
